(19) United States
(12) Patent Application Publication
(10) Pub. No.: US 2005/0214181 A1
(43) Pub. Date: Sep. 29, 2005

(54) Dielectric, gas treatment apparatus using the same, and plasma generator

(75) Inventors: Yoshiaki Kaneko, Tokyo (JP); Toshiji Nishiguchi, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/086,299

(22) Filed: Mar. 23, 2005

(30) Foreign Application Priority Data
Mar. 26, 2004 (JP) 2004-093347
Apr. 30, 2004 (JP) 2004-135626

(51) Int. Cl. B01J 19/08

(52) U.S. Cl. 422/186.04

(57) ABSTRACT

A plasma generator for producing plasma under normal pressure by applying a voltage between a ground electrode and a high-voltage electrode, the plasma generator including the ground electrode, the high-voltage electrode, and a dielectric member arranged between the ground electrode and the high-voltage electrode, in which the dielectric member has a structure including a porous ceramic substrate covered with an inorganic dielectric substance.

### BACKGROUND OF THE INVENTION

1. Field of the Invention

The present invention relates to a dielectric used in a gas treatment apparatus for detoxifying a gas containing volatile organic compounds (hereinafter, referred to as VOC) discharged from various industrial processes through a non-thermal plasma decomposition method, to a gas treatment apparatus using the same, and to a plasma generator.

2. Related Background Art

VOC are toxic chemical substances such as toluene, xylene, and methyl ethyl ketone (MEK) generated during a coating process or the like employing an organic solvent. In actuality, VOC had been emitted into atmosphere. However, reduction of VOC which are substances applying environmental load has been demanded socially, reflected by a recent enforcement of Pollutant Release and Transfer Register (PRTR), for example. Thus, a VOC detoxification technique has been studied extensively. The VOC detoxification technique employs a photodecomposition method, a catalyst decomposition method, a power burner combustion method, and the like, but those techniques have problems such as increase in apparatus size, increase in operational cost, generation of toxic substances, and treatment efficiency. An electric discharge-type VOC detoxification technique has attracted attention recently as a technique for overcoming those problems. The electric discharge-type VOC detoxification technique involves: generating electric discharge under atmospheric pressure; and treating VOC by means of the electric discharge. The electric discharge-type technique is classified into a silent discharge method, a surface discharge method, a pulse corona discharge method, a filled dielectric discharge decomposition method, or the like according to an electric discharge method. Of those, the filled dielectric discharge decomposition method can be used at atmospheric pressure and has a simple apparatus constitution requiring no additional equipment such as a vacuum pump. Further, the filled dielectric discharge decomposition method has high treatment efficiency, and thus is regarded as one of promising techniques.

The filled dielectric discharge decomposition method involves: applying a voltage to a dielectric; inducing glow discharge at atmospheric pressure in a gap between dielectrics; and generating plasma. Further, the atmospheric decomposition method involves: passing VOC as a treatment target gas through the gap in which plasma is generated; and decomposing VOC by an oxidative effect of plasma into carbon dioxide and water. Thus, in the filled dielectric discharge decomposition method, it is important to generate plasma efficiently, and several techniques are disclosed therefor.

First, there is disclosed a filled dielectric barrier discharge generator for generating electric discharge, including: a pair of electrodes; and a particulate dielectric formed by covering an entire surface of a conductor with an insulator and filled between the pair of electrodes (see Japanese Patent Application Laid-Open No. H08-321397, for example). The technique can generate homogeneous glow discharge with application of a very small voltage even with a gas such as oxygen or nitrogen having a large discharge starting voltage because a gap between the particulate dielectrics is small.

However, when the dielectric pellets are filled between the electrodes, a void ratio is considerably reduced, causing a large pressure loss while a gas flows through a plasma space. Thus, there is disclosed a technique involving: arranging a dielectric formed by covering a three dimensional porous ceramic with a catalyst instead of the dielectric pellets between electrodes; and generating plasma (see Japanese Patent Application Laid-Open No. H11-128728, for example). The three dimensional porous ceramic has a large porosity, and thus has merits such as a larger plasma space volume than that of the dielectric pellets, a smaller pressure loss than that of the dielectric pellets, and small power required for a fan.

When the dielectric including a catalyst supported on a porous ceramic as described in Japanese Patent Application Laid-Open No. H11-128728 is used, treatment efficiency improves more than when the dielectric pellets are used. However, a large concentration of VOC or a large gas flow rate requires increase in volume of a plasma production portion, increase in applied voltage, or combination of both measures, to thereby improve treatment performance. Thus, the technique has problems of increase in apparatus cost or operational cost.

Further, electrical characteristics of the dielectric are generally affected by temperature. Thus, it is pointed out that increase in applied voltage causes problems of heat generation of the dielectric, adverse effects on a plasma state, and reduction in treatment efficiency. In order to solve the problems, it is effective to increase a gas flow rate and thus enhance an air cooling effect, which may disadvantageously cause increase in fan capacity or increase in fan power due to increased pressure loss.

### SUMMARY OF THE INVENTION

The present invention has been made in view of the above circumstances, and an object of the present invention is therefore to provide a dielectric applicable to a gas treatment apparatus of a filled dielectric discharge decomposition method, and more specifically to a dielectric which is capable of producing plasma at a low voltage, which has high treatment efficiency, and which is capable of maintaining stable plasma by suppressing heat generation of the dielectric. Another object of the present invention is to provide a gas treatment apparatus or the like using the dielectric.

A dielectric of the present invention has a gas passage and produces plasma in the passage under atmospheric pressure by applying a voltage. The dielectric includes: a dielectric substrate having pores; a ferroelectric film covering surfaces of the pores and having a larger dielectric constant than that of the dielectric substrate; an adsorbent covering a surface of the ferroelectric film; and a catalyst covering a part of a surface of the adsorbent and forming an outer peripheral portion of the passage together with the adsorbent.

In the dielectric having such a constitution, a treatment target substance flows through the passage in which plasma is generated for oxidation thereof, to thereby allow detoxification of the treatment target substance. Oxidation of the treatment target substance is accelerated by means of the catalyst, and treatment efficiency is further enhanced. The treatment target substance is efficiently trapped within the passage by means of the adsorbent. Thus, the treatment target substance is more assuredly oxidized, and an untreated part is hardly discharged out of a system. In addition, the dielectric having a structure including the dielectric substrate covered with the ferroelectric film of a larger dielectric constant than that of the dielectric member allows plasma production from a ferroelectric film at a low voltage. Further, heat generation of the dielectric can be suppressed, to thereby suppress adverse effects on plasma production characteristics and maintain stable plasma.

A plasma generator of the present invention for producing plasma under normal pressure by applying a voltage between a ground electrode and a high-voltage electrode includes: the ground electrode; the high-voltage electrode; and a dielectric member arranged between the ground electrode and the high-voltage electrode, in which the dielectric member has a structure including a porous ceramic substrate covered with an inorganic dielectric substance.

According to a preferable aspect of the present invention, the dielectric member has a structure including a honeycomb ceramic substrate covered with an inorganic dielectric substance.

The plasma generator having such a constitution can increase a ratio of a plasma space volume to a plasma reactor volume and increase electric power efficiency without reducing a plasma density of the plasma space. Further, the plasma generator having such a constitution can have reduced electric power consumption due to heat generation and reduced discharge starting voltage to a low voltage compared to those of a plasma generator having a constitution including a porous ceramic member formed of a single substance of a ferroelectric substance or a substance having a small dielectric constant arranged between electrodes.

As described above, the dielectric of the present invention can treat the treatment target substance by means of not only plasma but also the catalyst, and can efficiently trap the treatment target substance within the passage by means of the adsorbent. Further, heat generation of the dielectric can be suppressed, contributing to stabilization of plasma. For those reasons, the following effects can be provided.

(1) Performance (treatment rate) of the treatment target substance is improved.

(2) An increase in equipment cost due to increase in apparatus size or the like can be suppressed because filled dielectric discharge decomposition of high treatment efficiency can be realized.

(3) An applied voltage may be reduced, and an operational cost can be reduced.

(4) Plasma is stabilized to facilitate an operation for a long period of time, and an unnecessary adjustment time or stopping time can be eliminated. As a result, operation efficiency improves.

Further, the plasma generator of the present invention can realize plasma production at a large ratio of a plasma space volume to a plasma reactor volume, and further plasma production with high electric power efficiency.

### BRIEF DESCRIPTION OF THE DRAWINGS

FIG. 1 is a schematic diagram showing a constitution of a gas treatment apparatus according to an embodiment of the present invention;

FIG. 2 is a schematic perspective view of a gas treatment portion of the gas treatment apparatus shown in FIG. 1;

FIG. 3 is a schematic sectional view showing the vicinity of a surface of a dielectric constituting the gas treatment portion shown in FIG. 2;

FIGS. 4A and 4B are each a schematic diagram of a plasma generator according to an embodiment of the present invention, and FIGS. 4A and 4B are each a sectional view taken along a plane perpendicular to each other;

FIGS. 5A and 5B are each a schematic diagram of a plasma generator according to another embodiment of the present invention, and FIGS. 5A and 5B are each a sectional view taken along a plane perpendicular to each other;

FIGS. 6A and 6B are each a schematic diagram of a dielectric member used for the plasma generator shown in FIGS. 5A and 5B, and FIG. 6A is a perspective view and FIG. 6B is a partially enlarged front view;

FIG. 7 is a diagram showing a constitution of a gas treatment apparatus using a plasma generator having the same constitution as that shown in FIGS. 4A and 4B;

FIG. 8 is a diagram showing a constitution a gas treatment apparatus using a plasma generator having the same constitution as that shown in FIGS. 5A and 5B;

FIG. 9 is a schematic diagram of a plasma generator according to still another embodiment of the present invention;

FIG. 10 is a diagram showing a constitution of a gas treatment apparatus used in Example 1 and Comparative Examples 1 and 2;

FIGS. 11A and 11B are a table and a graph showing test results of Example 1 and Comparative Examples 1 and 2;

FIG. 12 is a diagram showing a constitution of a gas treatment apparatus used in Example 2;

FIG. 13 is a diagram showing a constitution of a gas treatment apparatus used in Comparative Example 3;

FIGS. 14A and 14B are diagrams showing a constitution of a gas treatment apparatus used in Comparative Example 4;

FIG. 15 is a graph showing results obtained in Example 2 and Comparative Examples 3 and 4, regarding a change in ammonia treatment rate with respect to electric power consumption;

FIG. 16 is a graph showing results obtained in Example 2 and Comparative Examples 3 and 4, regarding a change in ammonia treatment rate with respect to applied voltage; and

FIG. 17 is a graph showing results obtained in Example 2 and Comparative Examples 3 and 4, regarding a change in electric power consumption with respect to applied voltage.

### DESCRIPTION OF THE PREFERRED EMBODIMENTS

Hereinafter, embodiments of a dielectric and a gas treatment apparatus using the dielectric of the present invention will be described using figures. The gas treatment apparatus of the present invention can treat VOC or odor substances, and can be widely used for: soil contamination treatment; or gas treatment in a space requiring deodorization such as an indoor space where people gather, a living room at home or the like, or the inside of a car.

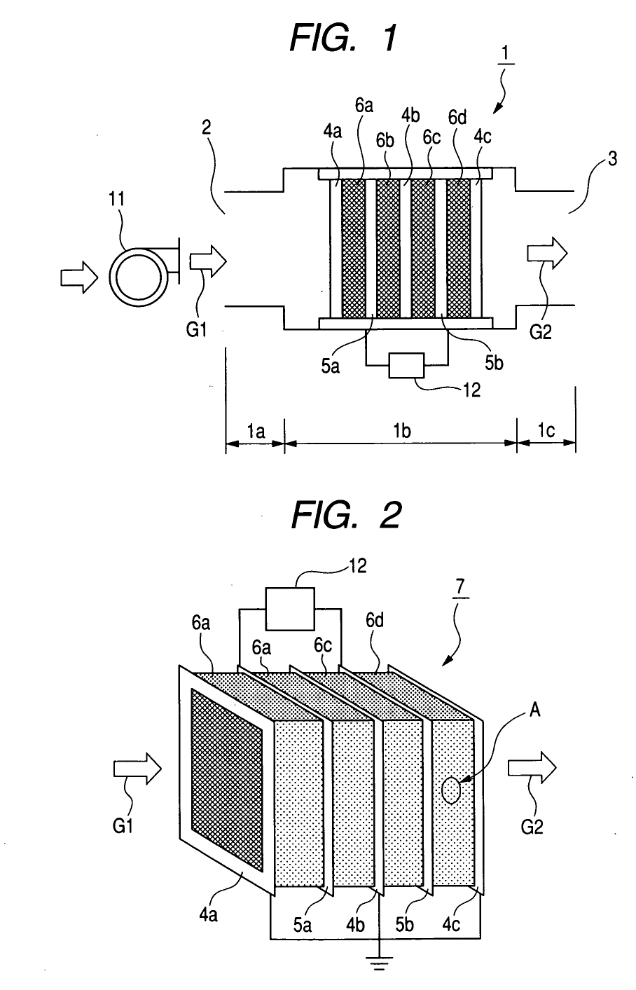

FIG. 1 is a schematic diagram showing a constitution of a gas treatment apparatus having a dielectric of the present invention. The gas treatment apparatus 1 is provided with: a gas introduction portion 1a including a gas introduction port 2 for introducing a gas to be treated G1, which is a treatment target substance; a plasma treatment chamber 1b for subjecting to plasma treatment the gas to be treated G1 flowing in from the gas introduction portion 1a; and a gas discharge portion 1c including a gas discharge port 3 for discharging out of a system a treated gas G2 subjected to the plasma treatment in the plasma treatment chamber 1b. Further, a fan 11 is provided downstream of the gas introduction portion la for feeding the gas to be treated G1 to the gas introduction portion 1a.

The plasma treatment chamber 1b is provided with a ground electrode 4a, a dielectric 6a, a high-voltage electrode 5a, a dielectric 6b, a ground electrode 4b, a dielectric 6c, a high-voltage electrode 5b, a dielectric 6d, and a ground electrode 4c in order from the downstream. Those members are each arranged across an entire region of a cross section of the plasma treatment chamber 1b such that a total volume of the gas to be treated G1 passes therethrough. The ground electrodes 4a, 4b, and 4c (hereinafter, may be abbreviated as ground electrodes 4a etc.) are each connected to the ground through an arbitrary method. The high-voltage electrodes 5a and 5b (hereinafter, may be abbreviated as high-voltage electrodes 5a etc.) are each connected to an AC high-voltage power supply 12. As a result, the high-voltage electrode 5a faces the ground electrodes 4a and 4b, and an AC voltage is applied to the dielectrics 6a and 6b provided between the ground electrode 4a and the high-voltage electrode 5a and between the ground electrode 4b and the high-voltage electrode 5a, respectively. The high-voltage electrode 5b faces the ground electrodes 4b and 4c, and an AC voltage is applied to the dielectrics 6c and 6d provided between the ground electrode 4b and the high-voltage electrode 5b and between the ground electrode 4c and the high-voltage electrode 5b, respectively. The number of the high-voltage electrodes and the ground electrodes can be arbitrarily changed according to the treatment target substance or the required treatment rate. The AC power supply can employ a frequency in a range of a commercial frequency of 50 Hz or 60 Hz to a high frequency (MHz) and often employs a voltage within a range of several kV to several tens kV, but is not particularly limited thereto.

FIG. 2 is a schematic perspective view of a cartridge having the ground electrodes, the high-voltage electrodes, and the dielectrics described above. A cartridge 7 is a package provided with ground electrodes 4a etc., high-voltage electrodes 5a etc., and dielectrics 6a to 6d (hereinafter, may be abbreviated as dielectrics 6a etc.), and can be loaded detachably onto the gas treatment apparatus 1 of FIG. 1. Thus, the cartridge 7 can be arbitrarily changed after being used for a certain period of time or according to a degree of performance degradation. Further, the gas treatment apparatus 1 of FIG. 1 has a holding portion (not shown) for holding the cartridge 7. Nevertheless, such a cartridge system is arbitrarily employed.

The high-voltage electrodes 5a etc. and the ground electrodes 4a etc. are each formed of a metal mesh, for example. The metal mesh differs depending on a type of the gas to be treated G1 but preferably consists of a thin metal wire of about 0.01 mm to 0.5 mm. A mesh size is appropriately selected to allow holding of the dielectrics 6a etc., uniform application of a voltage to the dielectrics 6a etc., and passage of the gas to be treated G1 therethrough without suffering a large pressure loss. Examples of a material for the metal mesh to be used include stainless steel, copper, brass, aluminum, iron, and tungsten.

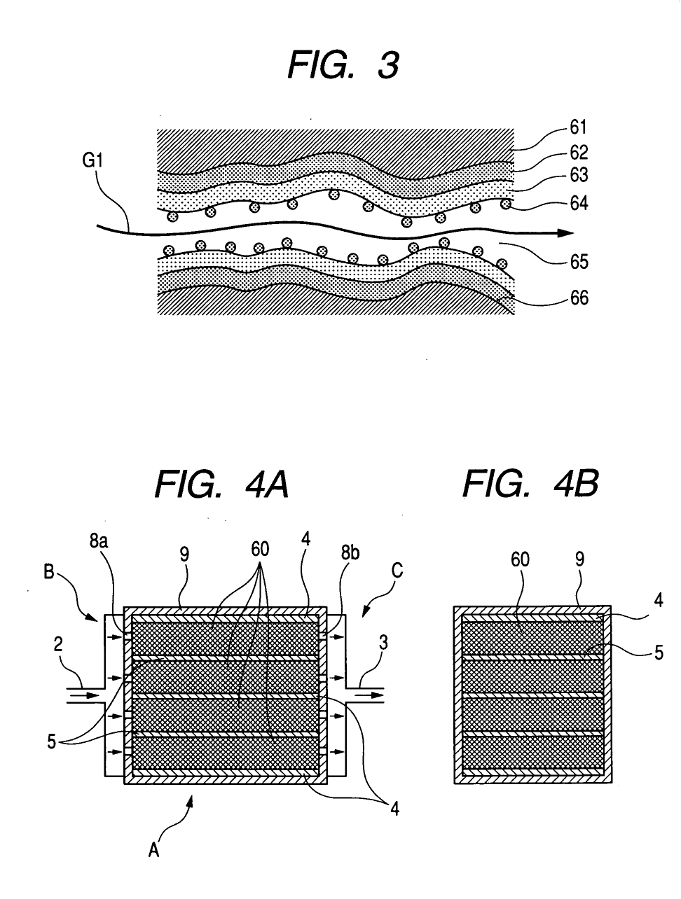

Next, a structure of the dielectric is described. FIG. 3 shows a partial detail drawing of the vicinity of a passage of the dielectric (A portion of FIG. 2 is shown as an example, but the same applies to other portions as well).

A basic structure of each of the dielectrics 6a etc. includes: a dielectric substrate 61 formed of a porous ceramic material as a skeleton portion; and a passage 65 (see FIG. 3) formed three dimensionally and in a network thereinside. The passage 65 is connected to another passage and is communicated therewith. Thus, the gas to be treated G1 introduced from an introduction port of each of the dielectrics 6a etc. reaches a gas discharge port and passes through each of the dielectrics 6a etc.

In FIG. 3, countless pores 66 extending three dimensionally and in a network are formed inside the dielectric member 61. A ferroelectric film 62 covers surfaces of the pores 66. An adsorbent 63 covers the ferroelectric film 62, and a catalyst 64 covers a part of the surface of the adsorbent 63. The catalyst 64 together with the adsorbent 63 forms an outer peripheral portion of the passage 65. The ferroelectric film 62, the adsorbent 63, and the catalyst 64 are thin, and thus do not clog the pores 66. The passage 65 does not shrink as much as the pores 66 of the dielectric substrate 61. Thus, the passage 65 is formed three dimensionally and in a network, similarly to the structure of the pores 66, and the gas to be treated G1 and the treated gas G2 can flow inside the passage 65. An average gap of the passage 65 is about 1 mm, and a porosity of the dielectric is about 80%, for example.

The dielectric substrate 61 desirably is formed of a ceramic substrate and has a dielectric constant of 50 or less. Alumina or zirconium oxide is used as the material for the dielectric substrate 61, for example.

The ferroelectric film 62 desirably has a dielectric constant of 1,000 or more, and examples thereof include barium titanate and strontium titanate. Other ceramics or ferroelectrics satisfying the above conditions can also be used. The ferroelectric film 62 consists of spherical pellets having a diameter of about 3 mm, and is preferably formed on the surface of the dielectric substrate 61 through calcination. In particular, the spherical pellets are more preferably calcined at a calcination temperature of 1,000° C. or higher, to thereby improve a dielectric constant of the ferroelectric film 62 to 1,000 or more. Whether the calcination is completed can be determined from a level of sintering of each of particles through observation of the surface of the film with a scanning electron microscope or a transmission electron microscope, and from sizes of voids after the formation of the ferroelectric film 62.

Zeolite, γ-alumina, or the like is used as the adsorbent 63. The use of zeolite allows removal of odor substances such as ammonia and toluene, and hydrophobic zeolite is particularly preferably used. When two or more dielectrics are arranged, each dielectric may be covered with the adsorbent of the same type or may be covered with the adsorbent of different types.

A noble metal or metal oxide such as platinum, palladium, rhodium, nickel, or manganese dioxide is preferably used as the catalyst 64. The catalyst 64 consists of spherical pellets having a diameter of about 2 mm, for example. Several types of catalyst may be used for the catalyst 64. When two or more dielectrics are used, each dielectric may use the catalyst of the same type or may use the catalyst of different types.

Next, a mechanism of the gas treatment apparatus 1 of the present invention will be described. In FIG. 1, the gas to be treated G1 containing VOC successively flows into the dielectrics 6a etc. in the plasma treatment chamber 1b from the gas introduction portion 1a by means of the fan 11. A voltage is applied between the ground electrodes 4a etc. and the high-voltage electrodes 5a by means of the high-voltage power supply 12. Electric discharge is generated in the passage 65 or on a wall surface of the passage 65 in the dielectrics 6a etc. interposed by the ground electrodes 4a etc. and the high-voltage electrodes 5a, thus producing plasma under normal pressure. The gas to be treated G1 flown into the passage 65 is oxidized and decomposed by plasma while being in contact with plasma, and then is detoxified. The detoxified treated gas G2 transfers to the gas discharge portion 1c and is discharged out of the system through the gas discharge port 3.

At this time, the catalyst 64 accelerates the oxidation of the gas to be treated G1, and thus treatment of the gas to be treated G1 is accelerated by a synergetic effect of the oxidation by means of the catalyst 64 and the oxidation by means of plasma. Further, the gas to be treated G1 is adsorbed on and trapped by means of the adsorbent 63 provided on the surface of the passage 65. Thus, the gas to be treated G1 is more assuredly oxidized, and the remained untreated gas is also adsorbed on the adsorbent 63 and is hardly discharged out of the system. Meanwhile, the ferroelectric film 62 having a large dielectric constant has a large polarizability of constituent particles and easily produces plasma at a low applied voltage, to thereby suppress large heat generation. Further, the ferroelectric film 62 is very thin and has a limited heat generation portion. Thus, overall heat generation can be suppressed in the dielectrics 6a etc., and an adverse effect on plasma due to temperature increase can be suppressed. Such a mechanism allows further improvement of the treatment efficiency and maintenance of stable plasma.

Hereinafter, preferable embodiments of the plasma generator of the present invention will be described using figures, but the present invention is not limited thereto.

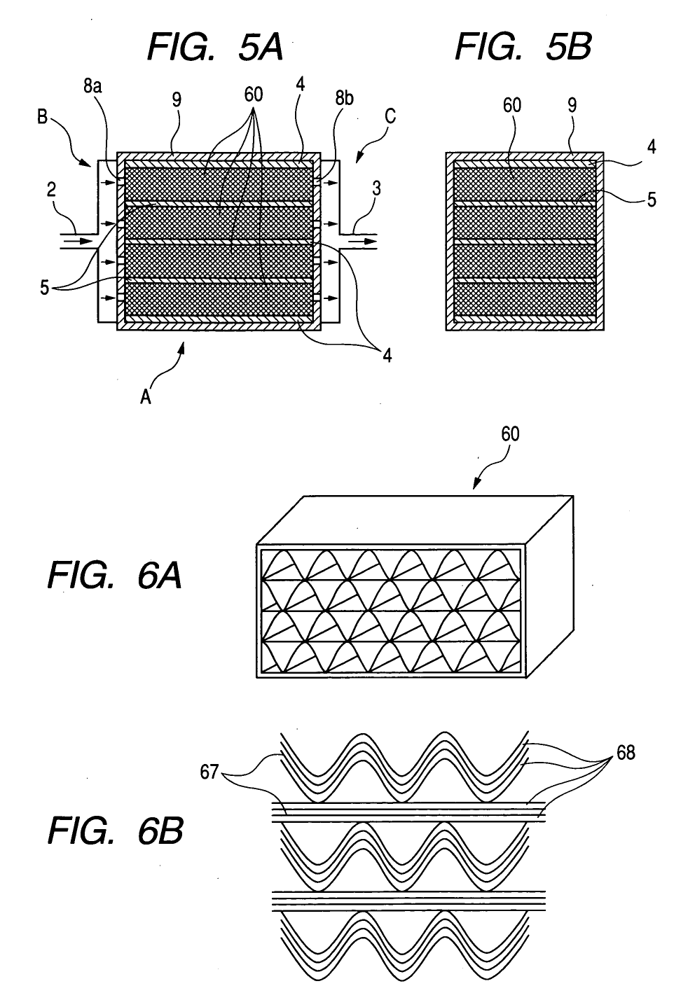

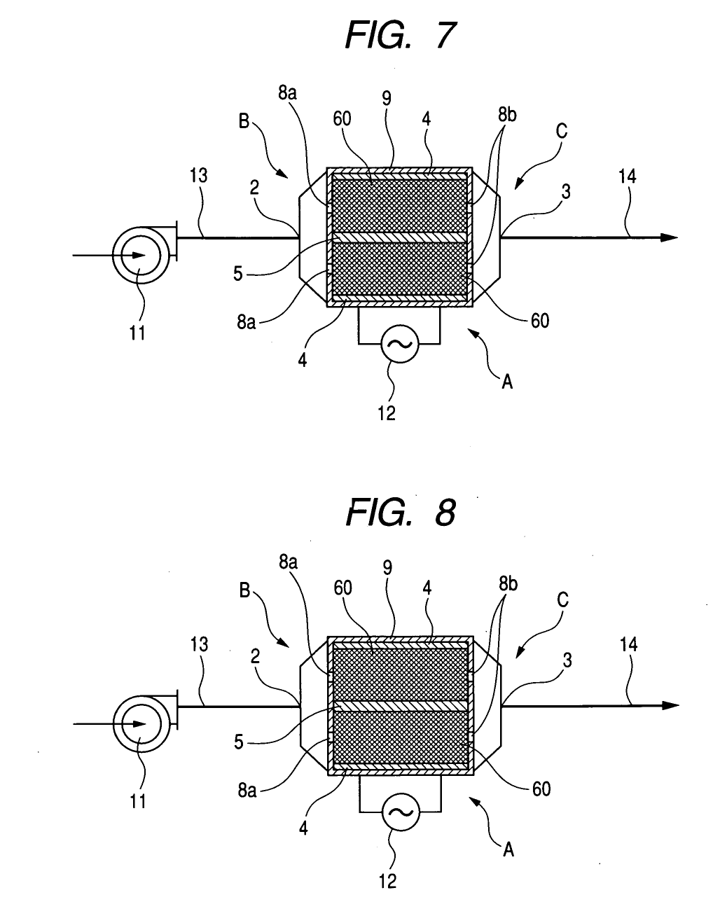

FIGS. 4A and 4B and FIGS. 5A and 5B are each a schematic diagram showing a constitution of a plasma generator according to an embodiment of the present invention. FIGS. 4A and 4B and FIGS. 5A and 5B are each a sectional view taken along a plane perpendicular to each other. FIGS. 6A and 6B are schematic diagrams of a dielectric member used in the plasma generator of FIGS. 5A and 5B. FIGS. 7 and 8 are each a schematic diagram showing a constitution example of a gas treatment apparatus employing the plasma generator having the same constitution as those of FIGS. 4A and 4B and FIGS. 5A and 5B.

The plasma generator shown in FIGS. 4A and 4B includes a plasma treatment chamber A, that is, a plasma reactor for conducting plasma treatment. The plasma treatment chamber A is provided with ground electrodes 4 and high-voltage electrodes 5 for applying a voltage and dielectric members 60 arranged therebetween, within an outer wall member 9. The ground electrodes 4 and the high-voltage electrodes 5 are arranged parallel to each other, interposing the dielectric members 60. That is, the plasma treatment chamber A is constituted as a parallel plate plasma reactor. A plurality of the ground electrodes 4 and the high-voltage electrodes 5 are arranged alternately to interpose a plurality of the dielectric members 60. The plasma treatment chamber A as a whole is constituted by laminating a plurality of plasma treatment units each constituted by the dielectric member 60, and the ground electrode 4 and the high-voltage electrode 5 sandwiching the dielectric member 60.

FIGS. 4A and 4B each show the plasma treatment chamber A having a rectangular shape, but the shape of the plasma treatment chamber A is not limited thereto. The same applies for the following respective figures as well.

On a side surface of the plasma treatment chamber A perpendicular to the ground electrodes 4 and the high-voltage electrodes 5, gas inlet pores 8a are formed for allowing a gas such as a gas to be treated to flow into the plasma treatment chamber A. On the opposite side wall, gas outlet pores 8b are formed for allowing the gas to flow out from the plasma treatment chamber A. The gas inlet pores 8a and the gas outlet pores 8b are provided at a plurality of positions on each of the dielectric members 60, corresponding to each plasma treatment unit.

A gas introduction port 2 for introducing a gas from outside of the system and a gas introduction portion B guiding the introduced gas to each of the gas inlet pores 8a are provided on a side of the plasma treatment chamber A where the gas inlet pores 8a are provided. Similarly, a gas discharge port 3 for discharging a gas out of the system and a gas discharge portion C for guiding the gas discharged from each of the gas outlet pores 8b to the gas discharge port 3 are provided on a side of the plasma treatment chamber A where the gas outlet pores 8b are provided.

In the plasma treatment apparatus of FIGS. 4A and 4B, each of the dielectric members 60 has a porous structure forming a three dimensional network structure, and a gap in the network structure serves as a gas passage. Each of the dielectric members 60, though not shown in detail, has a structure including a porous ceramic substrate covered with an inorganic dielectric substance and is formed by covering the porous ceramic substrate with the inorganic dielectric substance to be calcined.

In this case, the porous ceramic substrate has a smaller dielectric constant than that of the inorganic dielectric substance, and desirably has a dielectric constant of 50 or less. Specific examples of preferable ceramic described above include alumina and zirconium oxide. Meanwhile, the inorganic dielectric substance is a ferroelectric substance, and desirably has a dielectric constant of 1,000 or more. Specific examples of the inorganic dielectric substance described above include barium titanate and strontium titanate. However, the materials for the porous ceramic substrate and the inorganic dielectric substances are not limited to the above materials, and other ceramics and ferroelectrics satisfying the above conditions can be used.

The plasma generator shown in FIGS. 5A and 5B has the same constitution as that shown in FIGS. 4A and 4B except that the dielectric member 60 has a different structure. In FIGS. 5A and 5B, the same reference numerals as those of FIGS. 4A and 4B are used for the same parts, and detailed descriptions thereof are omitted.

As shown in FIGS. 6A and 6B, the dielectric member 60 of the plasma generator of FIGS. 5A and 5B has a structure including a honeycomb ceramic substrate 67 covered with an inorganic dielectric substance 68. The dielectric member 60 is formed by covering the honeycomb ceramic substrate with the inorganic dielectric substance to be calcined.

The honeycomb ceramic substrate 67 has a structure obtained by alternately laminating: a sheet ceramic which may be folded and which is molded and corrugated into a wavy sheet ceramic; and a flat sheet ceramic. A ceramic material constituting the honeycomb ceramic substrate 67 has a smaller dielectric constant than that of the inorganic dielectric substance 68, and desirably has a dielectric constant of 50 or less. Specific examples of such a preferable ceramic material include alumina and zirconium oxide. The inorganic dielectric substance 68 is a ferroelectric substance, and desirably has a dielectric constant of 1,000 or more. Specific examples of the inorganic dielectric substance 68 described above include barium titanate and strontium titanate. However, the materials for the honeycomb ceramic substrate 67 and the inorganic dielectric substances 68 are not limited to the above materials, and other ceramics and ferroelectrics satisfying the above conditions can be used.

The plasma generator having the parallel plate plasma reactor shown in each of FIGS. 4A and 4B and FIGS. 5A and 5B can be used for detoxifying a gas containing volatile toxic substances as a gas to be treated through the plasma treatment in the gas treatment apparatus shown in each of FIGS. 7 and 8, for example. In the gas treatment apparatus shown in each of FIGS. 7 and 8, an introduction pipe 13 provided with a fan 12 for passing through a gas to be treated is connected to the gas introduction port 2 of the plasma generator having the same constitution as those of FIGS. 4A and 4B and FIGS. 5A and 5B, and a gas discharge pipe 14 for discharging the treated gas is connected to the gas discharge port 3. Further, a high-voltage power supply 12 is connected between a ground electrode 4 and a high-voltage electrode 5. The plasma generator shown in each of FIGS. 7 and 8 has the same constitution as those of FIGS. 4A and 4B and FIGS. 5A and 5B except that the number of the plasma treatment units is different. The number of the plasma treatment units is not limited to those shown in the figures, and may be changed arbitrarily.

Gas treatment using the gas treatment apparatus described above is conducted as follows. That is, the fan 12 is started, and the gas to be treated flows into each plasma treatment unit in the plasma treatment chamber A from the gas introduction portion B. The gas to be treated flows in each plasma treatment unit while being in contact with the dielectric member 60. At this time, a voltage is applied between the ground electrode 4 and the high-voltage electrode 5 by means of the high-voltage power supply 12. Thus, in each plasma treatment unit, electric discharge is generated in gap space portions of the dielectric member or on gap wall surfaces thereof under normal pressure to produce plasma. Then, the gas to be treated is decomposed by means of plasma and is detoxified. The gas thus detoxified through the plasma treatment in each plasma treatment unit flows out to the gas discharge portion C, and is discharged out of the system through the gas discharge port 3.

The aforementioned embodiments of the present invention allow increase in void ratio in the plasma treatment chamber A, that is, the plasma reactor, without considerable reduction of a plasma density to provide a large plasma space volume ratio, and increase in electric power efficiency. Further, the embodiments of the present invention allow reduction in electric power consumption due to heat generation and reduction in discharge starting voltage to a low voltage compared to those of a plasma generator having a constitution including a porous ceramic member formed of a single substance of a ferroelectric substance or a substance having a small dielectric constant arranged between electrodes.

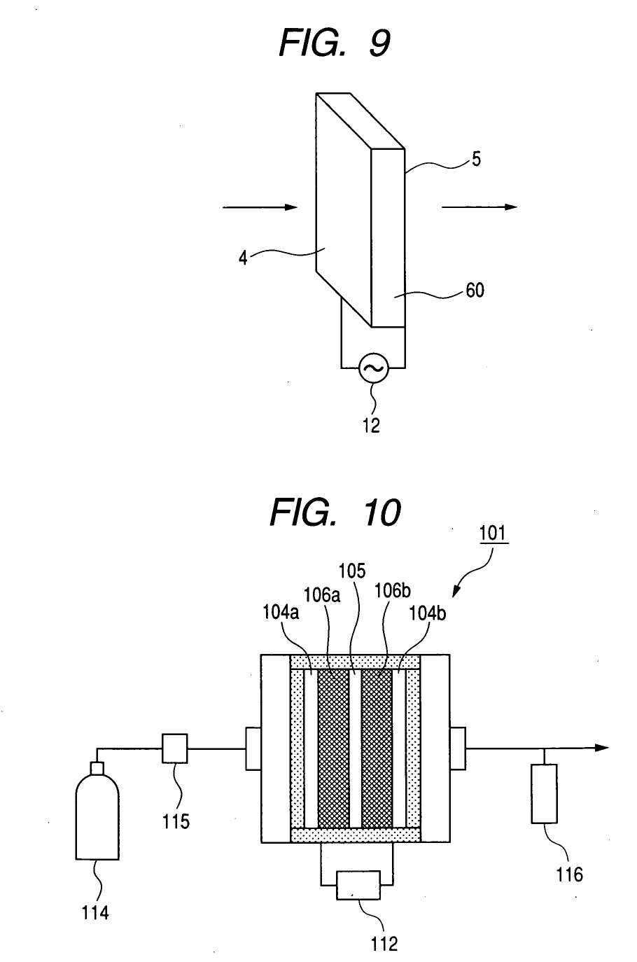

The parallel plate plasma reactor may have a constitution shown in FIG. 9. The constitution shown in FIG. 9 includes a ground electrode 4 and a high-voltage electrode 5 of a mesh structure allowing gas passage. In the constitution, a gas to be treated flows in a direction perpendicular to the ground electrode 4 and the high-voltage electrode 5 as shown by the arrows in the figure to be treated. At this point, a dielectric member 60 having a honeycomb structure may be arranged between the ground electrode 4 and the high-voltage electrode 5. In this case, the dielectric member 60 is constructed to allow gas passage between a surface of the dielectric member 60 on the side of the ground electrode 4 and a surface thereof on the side of the high-voltage electrode 5.

The plasma treatment of the gas to be treated by the parallel plate plasma reactor shown in FIG. 9 is conducted as follows, for example. That is, the gas to be treated such as a gas containing volatile toxic substances flows from one side of the ground electrode 4 and the high-voltage electrode 5. At this time, a voltage is applied between the ground electrode 4 and the high-voltage electrode 5 by means of the high-voltage power supply 12. Thus, electric discharge is generated in gap space portions of the dielectric member or on gap wall surfaces thereof under normal pressure to produce plasma. Then, the gas to be treated is decomposed by means of plasma and is detoxified. The gas detoxified through the plasma treatment in the plasma reactor flows out from the other side of the ground electrode 4 and the high-voltage electrode 5, and is discharged out of the system.

The effects of the dielectric of the present invention will be described in more detail by the following examples. However, the following examples are mere examples, and the scope of the present invention is not limited thereto.

### (Example 1)

FIG. 10 is a schematic diagram showing a constitution of a gas treatment apparatus used in Example 1 and Comparative Examples 1 and 2. A cylinder 114 of a gas to be treated filled with the gas to be treated is connected to a gas introduction port of a gas treatment apparatus 101 through a flow controller 115. A plasma treatment chamber has a chamber volume of 16 cm³. A gas discharge port is connected to an analytical instrument 116 (gas detector tube, manufactured by Gastec Corporation) through a pipe. The gas to be treated is an ammonia gas of 10 ppm, and a flow rate thereof is 16 l/min.

A constitution of electrodes/dielectric of Example 1 is somewhat simplified compared to those described in the above embodiments, and includes: a high-voltage electrode 105 (tungsten bar of 1 mmφ) connected to a high-voltage power supply 112; ground electrodes 104a and 104b (stainless steel mesh) on both sides of the high-voltage electrode 105; and dielectrics 106a and 106b (outer size of 40 mm×40 mm×5 mm) interposed by the ground electrode 104a and the high-voltage electrode 105 and by the ground electrode 104b and the high-voltage electrode 105, respectively. The dielectrics 106a and 106b were prepared by: applying barium titanate (dielectric constant of ε=4,000) as a ferroelectric film on a porous alumina substrate; calcining the whole at 1,250° C.; applying high silica zeolite thereon as an adsorbent; and using nickel as a catalyst. The ferroelectric film had a thickness of 20 μ, an adsorbent application amount of 35 wt %, and a catalyst amount of 0.5 wt %. An average gap of passages in the dielectrics 106a and 106b was 1 mm, and a porosity of the dielectrics was 80%.

(Comparative Examples 1 and 2)

In Comparative Example 1, the ferroelectric film and the catalyst were provided on the porous alumina substrate, but the adsorbent was not provided thereon. In Comparative Example 2, the adsorbent and the catalyst were provided on the porous alumina substrate, but the ferroelectric film was not provided thereon. Other conditions were the same as those of Example 1. The detoxification treatment of the gas to be treated was conducted using the gas treatment apparatus 101 for Example 1 and Comparative Examples 1 and 2.

(Evaluation)

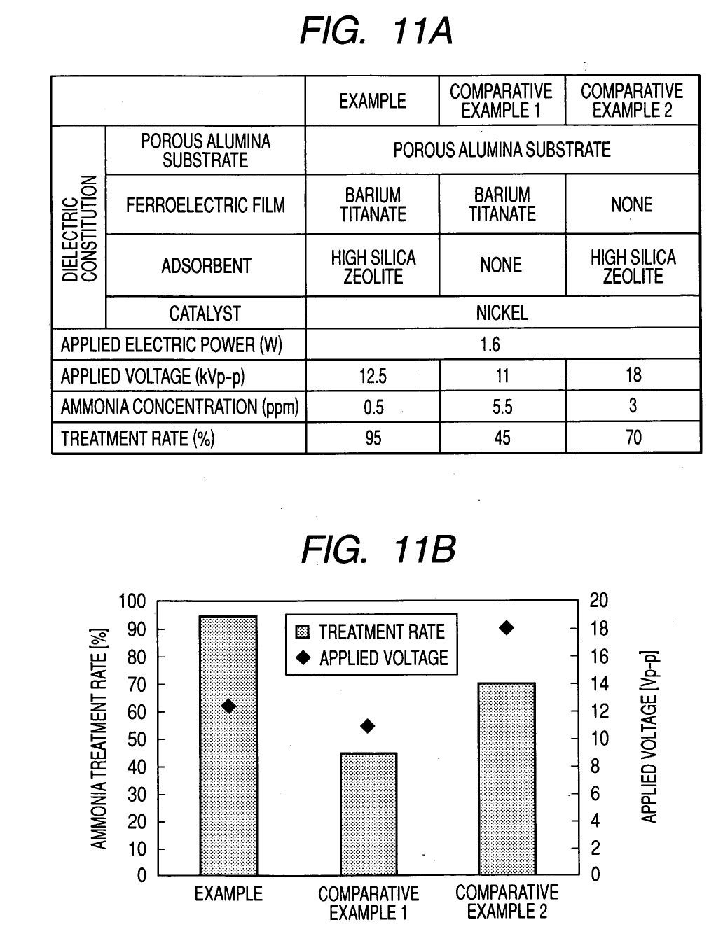

FIGS. 11A and 11B show the results. FIG. 11A is a table of basic conditions and results of each example. FIG. 11B shows a relationship between applied voltage and treatment rate of each example. The treatment rate is defined by the following equation.
Treatment rate =(1−(outlet concentration/inlet concentration))×100
In Comparative Example 1, the adsorbent was not applied, and thus a plasma space could not hold ammonia. A contact time of ammonia with the plasma or the catalyst is shorter than that of Example 1, and thus Comparative Example 1 had poor treatment ability. In Comparative Example 2, the applied voltage was about 1.5 times higher than that of Example 1, but the treatment rate remained at 70%. The applied voltage must be further increased to obtain a treatment rate comparable to that of Example 1. This is because barium titanate was not applied in Comparative Example 2 and thus the applied voltage required for electric discharge was higher. As a result, an applied voltage had to be higher than that of Example 1 for obtaining a desired treatment rate, which increases electric power consumption. Further, heat generation increases, which is not preferable for plasma stabilization.

As described above, the gas treatment apparatus of the present invention allows detoxification of the gas to be treated by: flow of the gas to be treated as a treatment target substance through the passage in which plasma is generated for oxidation; and oxidation of the gas to be treated by means of the catalyst. Further, the gas to be treated is assuredly trapped within the passage by means of the adsorbent to enhance efficiency of oxidation treatment, and an untreated part is hardly discharged out of the system. Meanwhile, the dielectric substrate is covered with a ferroelectric film having a higher dielectric constant than that of the dielectric substrate, and thus plasma can be generated with a low applied voltage. Heat generation of the dielectric can be suppressed, contributing to stabilization of plasma. As a result, not only performance (treatment rate) is improved, but also a facility cost or an operational cost may be reduced or operation efficiency may be improved.

### (Example 2)

In Example 2, detoxification treatment of a gas containing a volatile substance was conducted using a gas treatment apparatus having a different constitution as follows.

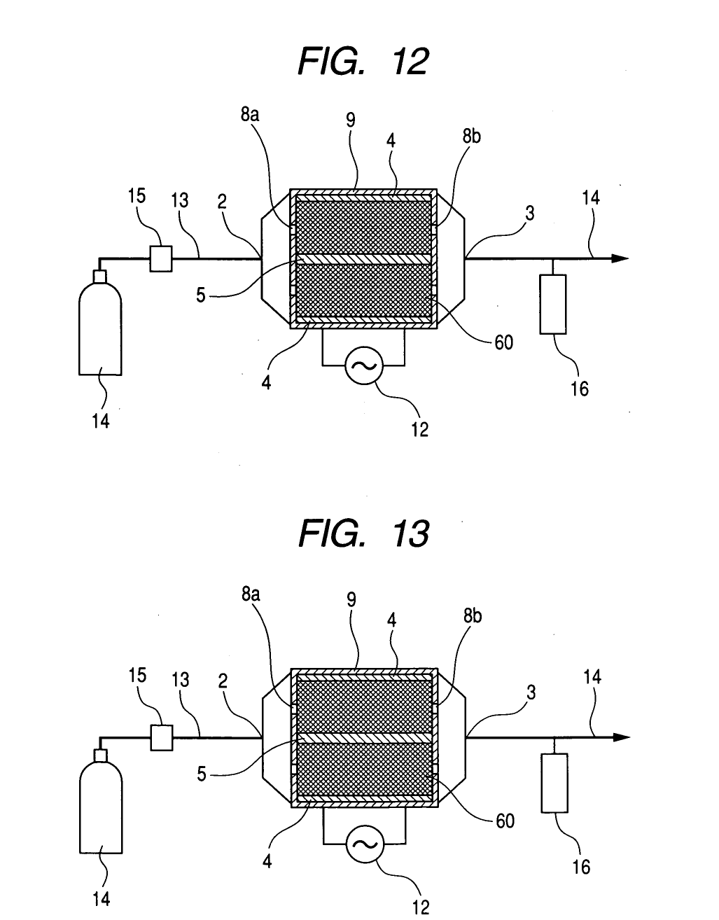

FIG. 12 is a schematic diagram showing a constitution of a gas treatment apparatus employing a plasma generator used in Example 2. The gas treatment apparatus employed a plasma generator having a parallel plate plasma reactor of the same constitution as that shown in FIGS. 4A and 4B. A gas introduction pipe 13 connected to a gas introduction port 1 of the plasma generator extended from a gas cylinder 14 of a gas to be treated, and was provided with a gas flow controller 15. An analytical instrument 16 was connected to a gas discharge pipe 14 connected to a gas discharge port 3. A high-voltage power supply 12 was connected between a ground electrode 4 and a high-voltage electrode 5 of the plasma generator. A dielectric member 60 used was prepared by: applying barium titanate (dielectric constant of ε=1,600) on a porous alumina substrate; and calcining the whole at 1,250° C. A void ratio of the dielectric member 60 as a whole, that is, a porosity thereof was 80%.

A plasma reactor used had an inner volume of 30 ml. The high-voltage electrode 5 and the ground electrode 4 each had a size of 50 mm×30 mm×10 mm, and an interelectrode distance was 10 mm. A gas detector tube (manufactured by Gastec Corporation) was used as an analytical instrument 16.

Plasma treatment was conducted using the gas treatment apparatus by: passing an ammonia gas of 10 ppm at a flow rate of 6 l/min; and changing an applied voltage from 15 kVp-p to 23kVp-p. A gas after undergoing electric discharge treatment was analyzed, resulting in: an ammonia concentration of 0 ppm to about 7 ppm; and a treatment rate of 30% to 100%. Electric power consumption was 1.0 W to 4.0 W.

(Comparative Example 3)

In Comparative Example 3, a gas treatment apparatus having a constitution shown in FIG. 13 was used. In the gas treatment apparatus shown in FIG. 13, a plasma generator shown in FIG. 9 was used. The gas treatment apparatus differs from that of Example 2 shown in FIG. 12 in that the plasma generator employed a dielectric member 60 including a plurality of spherical dielectrics arranged. Particulate barium titanate (particle size of 3 mmφ, dielectric constant of ε=1,600) was used as the dielectric. A void ratio of the dielectric member 60 as a whole was 26%. The inner volume of the plasma reactor, the sizes of the high-voltage electrode 5 and the ground electrode 4, and the analytical instrument 16 used were the same as those of Example 2. In FIG. 13, the same reference numerals as those of FIG. 12 represent the same members as those of FIG. 12.

The plasma treatment was conducted in the same manner as in Example 2 using the gas treatment apparatus by passing an ammonia gas and changing an applied voltage. A gas after undergoing the electric discharge treatment was analyzed, resulting in: an ammonia concentration of 0 ppm to about 9.5 ppm; and a treatment rate of 5% to 100%. Electric power consumption was 1.0 W to 6.7 W.

(Comparative Example 4)

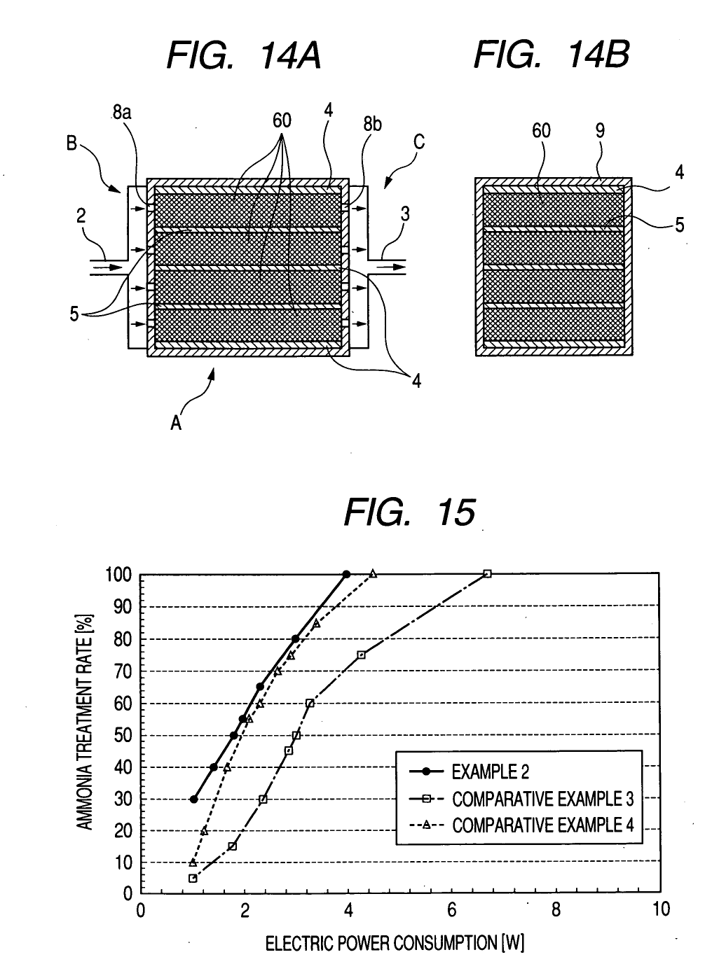

In Comparative Example 4, a gas treatment apparatus having a constitution shown in FIGS. 14A and 14B was used. The gas treatment apparatus shown in FIGS. 14A and 14B differs from that of Example 2 shown in FIG. 12 in that a dielectric member 60 includes only a porous ceramic substrate in the plasma generator shown in FIGS. 4A and 4B and is not covered with the inorganic dielectric substance. The inner volume of the plasma reactor, the sizes of the high-voltage electrode 5 and the ground electrode 4, and the analytical instrument 16 used were the same as those of Example 2. In FIGS. 14A and 14B, the same reference numerals as those of FIG. 12 represent the same members as those of FIG. 12.

The plasma treatment was conducted in the same manner as in Example 2 using the gas treatment apparatus by passing an ammonia gas and changing an applied voltage. A gas after undergoing the electric discharge treatment was analyzed, resulting in: an ammonia concentration of 0 ppm to about 9 ppm; and a treatment rate of 10% to 100%. Electric power consumption was 1.0 W to 4.0 W.

(Evaluation)

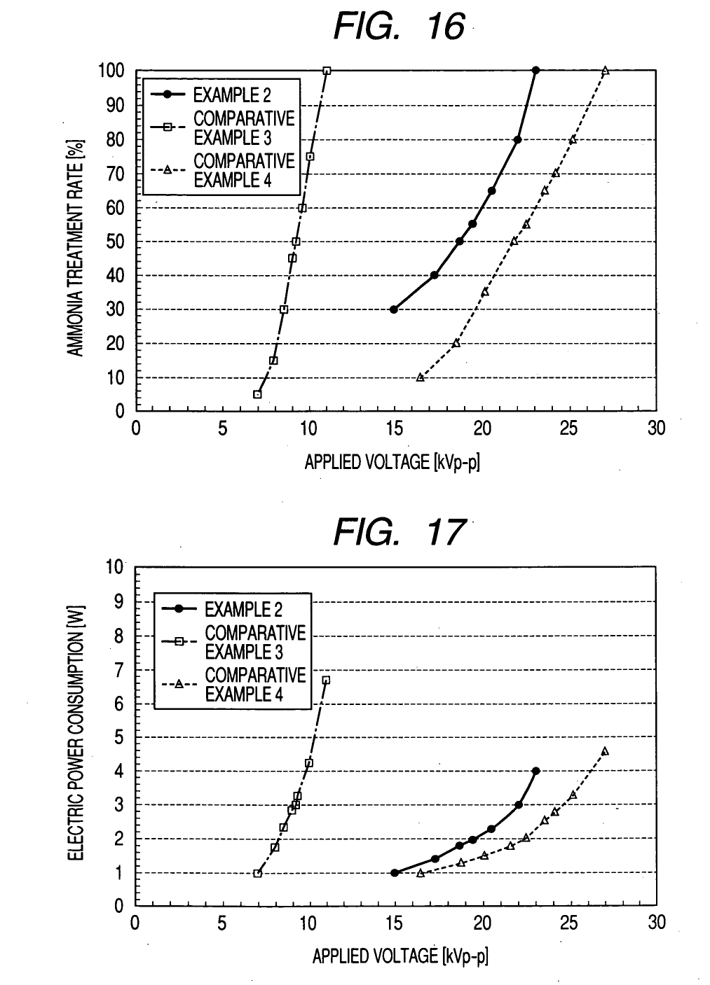

FIGS. 15 to 17 show graphs of the results obtained in Example 2 and Comparative Examples 3 and 4. FIG. 15 is a graph showing the results obtained in Example 2 and Comparative Examples 3 and 4, regarding a change in ammonia treatment rate with respect to electric power consumption. FIG. 16 is a graph showing the results obtained in Example 2 and Comparative Examples 3 and 4, regarding a change in ammonia treatment rate with respect to applied voltage. FIG. 17 is a graph showing the results obtained in Example 2 and Comparative Examples 3 and 4, regarding a change in electric power consumption with respect to applied voltage.

FIG. 15 reveals that the electric power consumption for obtaining a treatment rate of 100% was 4.0 W in Example 2 and 6.7 W in Comparative Example 3. That is, FIG. 15 indicates that the electric power consumption of Example 2 can be suppressed by 40% compared to that of Comparative Example 3.

FIG. 15 reveals that the ammonia treatment rates of Comparative Example 4 and Example 2 are substantially the same with substantially the same electric power consumption. However, FIG. 16 shows that the applied voltage of Example 2 can be suppressed compared to that of Comparative Example 4. That is, the applied voltage can be reduced to a low voltage during the treatment in Example 2 employing the dielectric member covered with barium titanate as an inorganic dielectric substance compared to that in Comparative Example 4 employing the dielectric member without covering.

This application claims priorities from Japanese Patent Application Nos. 2004-093347 filed on Mar. 26, 2004, and 2004-135626 filed on Apr. 30, 2004, those are hereby incorporated by reference herein.

1. A dielectric having a gas passage, for producing plasma in the passage under atmospheric pressure by applying a voltage, comprising:
a dielectric substrate having pores;
a ferroelectric film covering surfaces of the pores and having a larger dielectric constant than the dielectric constant of the dielectric substrate;
an adsorbent covering a surface of the ferroelectric film; and
a catalyst covering a part of a surface of the adsorbent and forming an outer peripheral portion of the passage together with the adsorbent.

2. The dielectric according to claim 1, wherein the passage is formed three dimensionally and in a network.

3. A gas treatment apparatus comprising:
the dielectric according to claim 1; and
a ground electrode and a high-voltage electrode interposing the dielectric for applying a voltage to the dielectric.

4. A cartridge for a gas treatment apparatus which can be loaded detachably onto the gas treatment apparatus, comprising:
the dielectric according to claim 1; and
a ground electrode and a high-voltage electrode interposing the dielectric for applying a voltage to the dielectric.

5. A gas treatment apparatus, comprising:
the cartridge according to claim 4; and
a holding portion in which the cartridge according to claim 4 can be loaded detachably.

6. A plasma generator for producing plasma under normal pressure by applying a voltage between a ground electrode and a high-voltage electrode, the plasma generator comprising:
the ground electrode;
the high-voltage electrode; and
a dielectric member arranged between the ground electrode and the high-voltage electrode, wherein
the dielectric member has a structure including a porous ceramic substrate covered with an inorganic dielectric substance.

7. The plasma generator according to claim 6, wherein the inorganic dielectric substance is a ferroelectric substance and is calcined after covering the porous ceramic substrate.

8. The plasma generator according to claim 6, wherein the porous ceramic substrate has a three dimensional network structure and comprises a material having a smaller dielectric constant than the dielectric constant of the inorganic dielectric substance.

9. A plasma generator for producing plasma under normal pressure by applying a voltage between a ground electrode and a high-voltage electrode, the plasma generator comprising:
the ground electrode;
the high-voltage electrode; and
a dielectric member arranged between the ground electrode and the high-voltage electrode, wherein
the dielectric member has a structure including a honeycomb ceramic substrate covered with an inorganic dielectric substance.

10. The plasma generator according to claim 9, wherein the honeycomb ceramic substance has a structure obtained by alternately laminating: a sheet ceramic which may be folded and which is molded and corrugated into a wavy sheet ceramic; and a flat sheet ceramic.

11. The plasma generator according to claim 9, wherein the inorganic dielectric substance is a ferroelectric substance and is calcined after covering the honeycomb ceramic substrate.

12. The plasma generator according to claim 9, wherein the honeycomb ceramic substrate comprises a material having a smaller dielectric constant than the dielectric constant of the inorganic dielectric substance.
